(19) United States
(12) Patent Application Publication
(10) Pub. No.: US 2008/0169235 A1
(43) Pub. Date: Jul. 17, 2008

(54) FILTER AND MANUFACTURING METHOD THEREFOR

(75) Inventor: Tatsuya GOTO, Aichi-ken (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 11/957,868

(22) Filed: Dec. 17, 2007

(30) Foreign Application Priority Data
Jan. 12, 2007 (JP) 2007-005102

(51) Int. Cl. B01D 35/30; B01D 29/05

(52) U.S. Cl. 210/454

(57) ABSTRACT

The filter 1 includes a first case member (an upper case member), a second case member (a lower case member) that are mutually joined to form a filter chamber therebetween, and a filter medium with an end portion held between the first and second case members. The first and second case members include holding portions, respectively, for holding the end portion of the filter medium in a bent position and welded portions, respectively, which are spaced apart from the holding portions and are welded together by a laser beam. The holding portions include vertical press surfaces, respectively, for pressing an inner end portion of the filter medium in the joining direction between the case members. The holding portions also include lateral press surfaces and, respectively, for pressing an outer end portion of the filter medium in a direction intersecting the joining direction.

### BACKGROUND OF THE INVENTION

1. Field of the Invention

The present invention relates to a filter and a manufacturing method therefor. More particularly, the present invention relates to an inexpensive and simply constructed filter capable of suppressing dislodgement of a filter medium during filter use and a manufacturing method therefor.

2. Description of the Related Art

An oil filter for an automatic transmission is known in which a first case member and a second case member are mutually joined to form a filter chamber, and a filter element is held between joining ends thereof (see Patent Documents 1, for example).

Patent Document 1 discloses one such filter that includes an upper cover member 14 and a lower cover member 16 joined together by causing spikes 56 on the lower cover member 16 to penetrate edges of a filter medium 20 and performing vibration welding to fuse a rib 60 located outwardly from the spikes 56. However, this filter is not free from several disadvantages. For example, since the filter is assembled by vibration welding, the upper and lower case members cannot be easily welded together immediately after the molding, thus lowering the production efficiency. Moreover, the filter has limited design freedom as restrictions are imposed on the shapes of the cover members and the like.

In order to solve the above-identified problems associated with the vibration welding of filter casing, a filter in which first and second case members are joined by laser welding has been proposed, for example, in Patent Document 2.

In particular, Patent Document 2 discloses a filter with an upper case member 7 and a lower case member 9 welded together by laser beam irradiation in an X direction. A filter element 5 is additionally welded to the lower case member 9 by laser beam irradiation in a Y direction. This structure permits the filter element to be stably welded to the case member and thus suppresses dislodgement of the filter element when the filter is in use.

In the case where the case member is made of polyamide or similar material and the filter medium (i.e., the filter element) is made of acryl or similar material, the softening temperature of the filter medium may be the same or lower than the melting temperature of the case member. In this case, the filter medium described in Patent Document 2 may be softened or deformed by the heat generated by the Y direction laser beam irradiation so that the filter medium may not be stably and firmly welded to the case members. This may cause the filter medium to be dislodged from the case members when the filter is in use.

Also in Patent Document 2, a laser beam needs to be irradiated twice to the case members, once from the X direction and once from the Y directions, which increases the overall cost and the cycle time for manufacturing the filter.

Patent Document 1: Japanese Patent Application Publication No. JP-A-11-156118

Patent Document 2: Japanese Patent Application Publication No. JP-A-2006-231875

### SUMMARY OF THE INVENTION

### Problems to be solved by the Invention

The present invention, which has been made in view of the foregoing, has an important object to provide a filter that is inexpensive and simply constructed and capable of preventing dislodgement of the filter medium during its use.

Another object of the present invention is to provide a method of manufacturing such a filter.

### Means for Solving Problem

1. A filter comprising:

a first case member and a second case member mutually joined to form a filter chamber; and

a filter medium having an end portion held between the first and second case members, wherein:

each of the first and second case members includes a holding portion for holding the end portion of the filter medium in a bent position and a welded portion spaced apart from the holding portion and welded by a laser beam; and

the holding portion includes:
a vertical press surface for pressing an inner end portion of the filter medium in a joining direction between the first and second case members; and
a lateral press surface for pressing an outer end portion of the filter medium in a direction intersecting the joining direction.

2. The filter according to 1 above, wherein one of the first and second case members includes on a periphery thereof a convex portion extending in the joining direction and the other case member includes on a periphery thereof a concave portion extending in the joining direction and engaged with the convex portion, and further wherein the holding portion is provided on the filter chamber side of where the convex portion engages the concave portion and the welded portion is provided on the side of where the convex portion engages the concave portion opposite to the filter chamber.

3. The filter according to 2 above, wherein the convex portion and the concave portion have respective tapered abutment surfaces that abut each other.

4. The filter according to 3 above, wherein the filter medium includes on a surface thereof a grid net and the vertical press surface has a plurality of protruding portions that penetrates a mesh of the grid net.

5. A manufacturing method for the filter of 1 above, comprising the steps of:

holding the end portion of the filter medium between the holding portions in a bent position by mutually joining the first case member and the second case member; and

irradiating a laser beam to one of the first and second case members via the other case member, with the end portion being held in the bent position, so as to form the welded portion, thus connecting the first and second case members; wherein,

in the holding step, the vertical press surface presses the inner end portion of the filter medium in the joining direction, while the lateral press surface presses the outer end portion of the filter medium in a direction intersecting the joining direction.

6. The manufacturing method according to 5 above, wherein one of the first and second case members includes on a periphery thereof a convex portion extending in the joining direction and the other case member includes on a periphery thereof a concave portion extending in the joining direction and engaged with the convex portion, and further wherein the holding portion is provided on the filter chamber side of where the convex portion engages the concave portion and the welded portion is provided on the side of where the convex portion engages the concave portion opposite to the filter chamber.

7. The manufacturing method according to 6 above, wherein the convex portion and the concave portion have respective tapered abutment surfaces that abut each other.

8. The manufacturing method according to 7 above, wherein the filter medium includes on a surface thereof a grid net and the vertical press surface has a plurality of protruding portions that penetrates a mesh of the grid net.

### EFFECT OF THE INVENTION

According to the filer of the present invention, since the holding portions, which hold the end portion of the filter medium, are spaced apart from the welded portions, which are welded together by the laser beam, the melting heat generated by the laser beam is not easily conducted to the filter medium, thus preventing undesirable effect on the shape or the quality of the material of the filter medium. Also, since the end portion of the filter medium is held in a bent position between the holding portions and the inner end portion of the filter medium is pressed by the vertical press surfaces in the joining direction, with the outer end portion of the filter medium being pressed by the lateral press surfaces in a direction intersecting the joining direction, the filter medium can be strongly supported between the two case members so as to prevent the filter medium from being dislodged when the filter is in use. Furthermore, since the first and second case members can be connected by a single execution of laser beam irradiation, the present invention provides an inexpensive and simply structured filter.

Additionally, in the case where the convex portion is provided along the periphery of one of the case members, the concave portion is provided along the periphery of the other case member, the holding portions are provided on the filter chamber side of where the convex portion engages the concave portion, and the welded portions are provided on the side of where the convex portion engages the concave portion opposite to the filter chamber, the convex portion engages the concave portion in a way that augments the mechanical bonding force during the welding by the laser beam and minimizes the warpage of the first and second case members, thus ensuring firm and secure joining of the case members. This structure also permits the holding portions to be sufficiently spaced apart from the welded portions and thus effectively inhibits the conduction of heat generated by the laser beam to the filter medium.

In the case where the convex portion and the concave portion have respective tapered abutment surfaces that abut with each other, this structure minimizes the gap at the engagement between the convex portion and the concave portion created by the warpage of the welded portions, thereby augmenting the welding strength therebetween.

In the filter of the present invention, the end portion of the filter medium is held between the holding portions in a bent position by joining the first case member and the second case member, and subsequently, a laser beam is irradiated to one of the first and second case members via the other case member so as to create the welded portions, thus connecting the first and second case members. In a filer thus provided, since the holding portions, which hold the end portion of the filter medium, are spaced apart from the welded portions, which are welded together by the laser beam, the melting heat generated by the laser beam is not easily conducted to the filter medium, thus preventing undesirable effect on the shape or the quality of the material of the filter medium. Also, the end portion of the filter medium is held in a bent position between the holding portions and the inner end portion of the filter medium is pressed by the vertical press surfaces in the joining direction, with the outer end portion of the filter medium being pressed by the lateral press surfaces in a direction intersecting the joining direction. Accordingly, the filter medium can be strongly supported between the two case members so as to prevent the filter medium from being dislodged when the filter is in use. Furthermore, since the first and second case members can be connected by a single execution of laser beam irradiation, the present invention provides an inexpensively and simply structured filter.

### BRIEF DESCRIPTION OF THE DRAWINGS

FIG. 1 is a vertical cross-sectional view of a filter of the present invention;

FIG. 2 is an enlarged view of an essential part of the filter shown in FIG. 1;

FIG. 3 is a perspective exploded view of an essential part of the filter shown in FIG. 1;

FIG. 4 is a cross-sectional view illustrating how to manufacture the filter shown in FIG. 1;

FIG. 5 is a cross-sectional view illustrating how to manufacture the filter shown in FIG. 1;

FIG. 6 is a vertical cross-sectional view of an essential part of a filter according to an alternate embodiment of the present invention;

FIG. 7 is a vertical cross-sectional view of an essential part of a filter according to another alternate embodiment of the present invention; and

FIG. 8 is a vertical cross-sectional view of an essential part of a filter according to still another alternate embodiment of the present invention.

### DESCRIPTION OF REFERENCE NUMERALS AND SIGNS

1; filter, 2; filter chamber, 3; upper case member, 4; lower case member, 5; filter medium, 12; end portion, 12a; inner end portion, 12b; outer end portion, 13; convex portion, 14; concave portion, 15, 16; holding portion, 15a, 16a; vertical press surface, 15b, 16b; lateral press surface, 20, 21; abutment surface, 22, 23; welded portion, L; laser beam, and P; joining direction.

### DETAILED DESCRIPTION OF THE PREFERRED EMBODIMENTS

### 1. Filter

A filter according to a first embodiment includes a first case member, a second case member, and a filter medium, which are described below.

The first case member and the second case member are not particularly limited in terms of shape, size, material or the like, provided that they are mutually joined to form a filter chamber. Typically, one of the first and second case members has a fluid inlet formed therein to introduce an unfiltered fluid thereto, whereas the other case member has a fluid outlet formed therein to discharge the fluid after it is filtered. Typically, one of the case members has laser transparency while the other case has laser absorbency.

Examples of materials for the first and second case members include non-crystalline resin, such as polystyrene (PS), low density polyethylene (LDPE), and polycarbonate (PC), as well as crystalline resin, such as polypropylene (PP), polybutylene terephthalate (PBT), polyethylene terephthalate (PET), polyamide (PA), and polyacetal (POM).

The filter medium is not particularly limited in terms of shape, size, material or the like, provided that an end thereof is held between the first and second case members. The filter medium divides the filter chamber into the dusty side and the clean side such that the fluid (such as oil) introduced into the dusty side is filtered and goes over to the clean side.

Conceivable shapes of the filter medium include a corrugated shape, single-sheet shape, folded shape formed of multiple sheets, wave shape, and the like. Examples of materials for the filter medium include non-woven fabric, woven fabric, paper, and the like. The filter medium may have laser transparency or laser absorbency.

In the filter of the first embodiment, the first and second case members each has a holding portion and a welded portion as described below.

The holding portions are not particularly limited in terms of shape, configuration, or the like, provided that they are capable of holding the end portion of the filter medium in a bent position. Each of the holding portions includes a vertical press surface that presses the inner end portion of the filter medium in the joining direction between the two case members. Each holding portion also includes a lateral press surface that presses the outer end portion of the filter medium in the direction intersecting the joining direction.

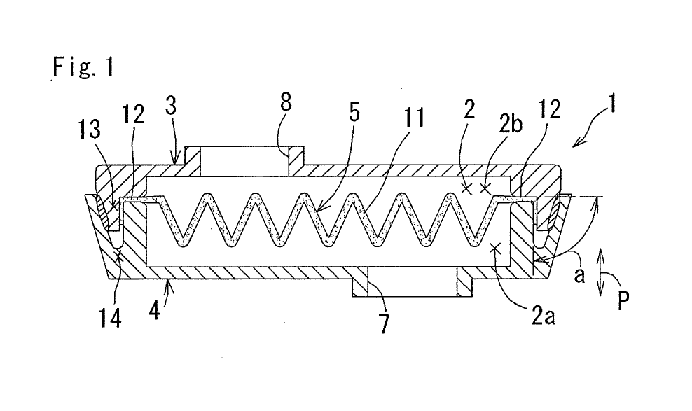

Although a bending angle “a” formed between the inner end portion and the outer end portion of the filter medium (see FIG. 1) is not particularly limited, provided that the selected angle prevents the filter medium from being dislodged, a preferred range is between 40 and 90 degrees and a more preferred range is between 60 and 90 degrees. The preferred ranges of angles ensure firmer engagement between the corners of the case members and the end portion of the filter medium and thus more strongly secure the filter medium between the case members.

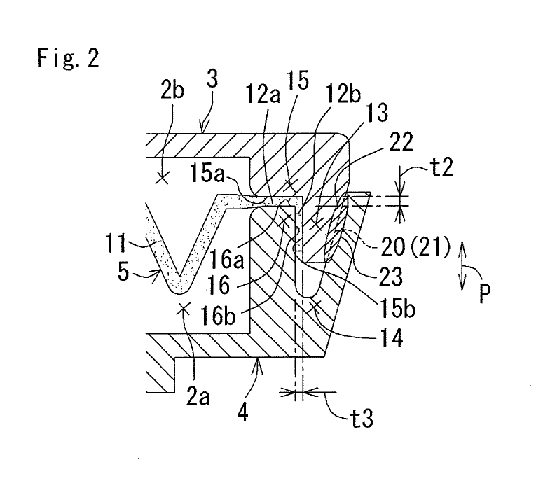

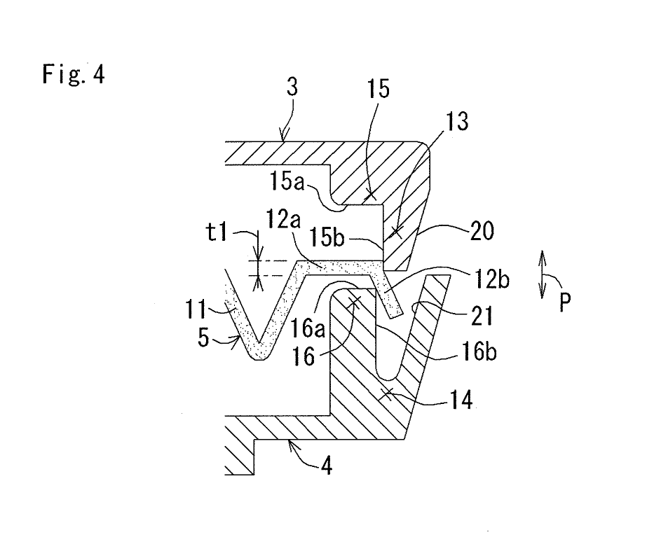

The compression ratio (t1/t2) of the thickness t1 of the inner end portion of the filter medium before pressing by the vertical press surfaces (see FIG. 4) to the thickness t2 of the inner end portion after the pressing (see FIG. 2) may be for example 2 or more (preferably 2.5 or more). Thereby, it is possible to suppress dislodgement of the filter medium from the filter casing by pressing to compress the end portion of the filter medium appropriately. The compression ratio (t1/t3) of the thickness t1 of the outer end portion of the filter medium before pressing by the lateral press surfaces (see FIG. 4) to the thickness t3 of the outer end portion after the pressing (see FIG. 2) may be, for example, 2 or more (preferably 2.5 or more). Thereby, it is possible to suppress dislodgement of the filter medium from the filter casing by pressing to compress the end portion of the filter medium appropriately.

The welded portions are not particularly limited in terms of shape, configuration, or the like, provided that they are spaced apart from the holding portions and they are welded together by a laser beam.

Typically, the laser beam is irradiated to the case member with laser absorbency via the case member with laser transparency to melt the portion to be welded of the former case member. The melting heat in turn melts the portion to be welded of the latter case member to form the welded portions between the two case members. Conceivable types of laser beam that may be used for the welding include semiconductor laser, gas laser, solid-state laser, and liquid laser beams.

As shown in FIG. 2, in the filter according to the first embodiment, one of the first and second case members may include on its periphery a convex portion 13 extending in the joining direction P, while the other case member may include on its periphery a concave portion 14 extending in the joining direction P and engaged with the convex portion 13. Furthermore, the first and second case members may include the holding portions 15 and 16 on the filter chamber side of where the convex portion 13 engages the concave portion 14 and the welded portions 22 and 23 on the side of where the convex portion 13 engages the concave portion 14 opposite to the filter chamber.

Conceivable configurations of the convex portion and the concave portion include those described in (1)-(4) below.

(1) Lateral press surfaces 15b and 16b extending in the joining direction P are provided on the holding portions 15 and 16, respectively, on the filter chamber side of where the convex portion 13 engages the concave portion 14, and tapered abutment surfaces 20 and 21 extending in a direction intersecting the joining direction P are provided on the convex portion 13 and the concave portion 14, respectively, on the side of where the convex portion 13 engages the concave portion 14 opposite to the filter chamber (see FIG. 2).

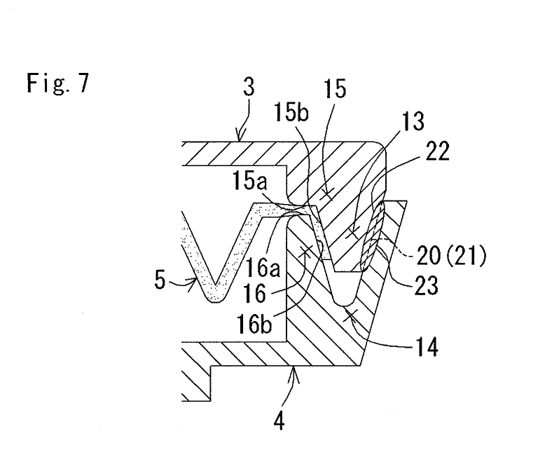

(2) Lateral press surfaces 15b and 16b extending in a direction intersecting the joining direction P are provided on the holding portions 15 and 16, respectively, on the filter chamber side of where the convex portion 13 engages the concave portion 14, and tapered abutment surfaces 20 and 21 extending in a direction intersecting the joining direction P are provided on the convex portion 13 and the concave portion 14, respectively, on the side of where the convex portion 13 engages the concave portion 14 opposite to the filter chamber (see FIG. 7).

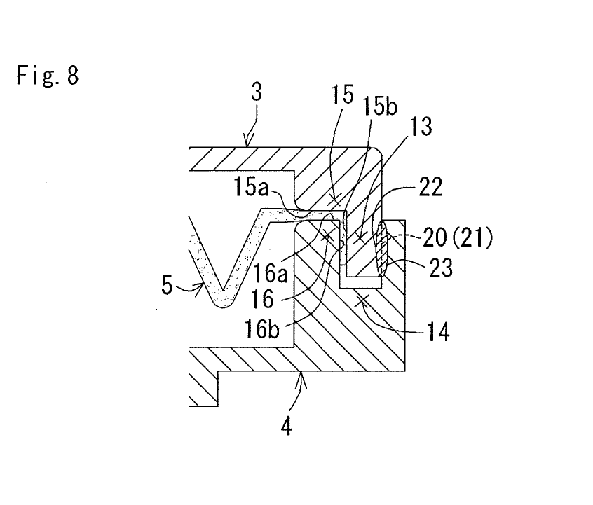

(3) Lateral press surfaces 15b and 16b extending in the joining direction P are provided on the holding portions 15 and 16, respectively, on the filter chamber side of where the convex portion 13 engages the concave portion 14, and abutment surfaces 20 and 21 extending in the joining direction are provided on the convex portion 13 and the concave portion 14, respectively, on the side of where the convex portion 13 engages the concave portion 14 opposite to the filter chamber (see FIG. 8).

(4) Lateral press surfaces extending in a direction intersecting the joining direction are provided on the holding portions on the filter chamber side of where the convex portion engages the concave portion, and abutment surfaces extending in the joining direction are provided on the convex portion and the concave portion on the side of where the convex portion engages the concave portion opposite to the filter chamber.

Among these, the most preferred configuration is the one described in (1) from the viewpoint of more reliably inhibiting dislodgement of the filter medium and augmenting the mechanical bonding strength of the case members during the laser welding.

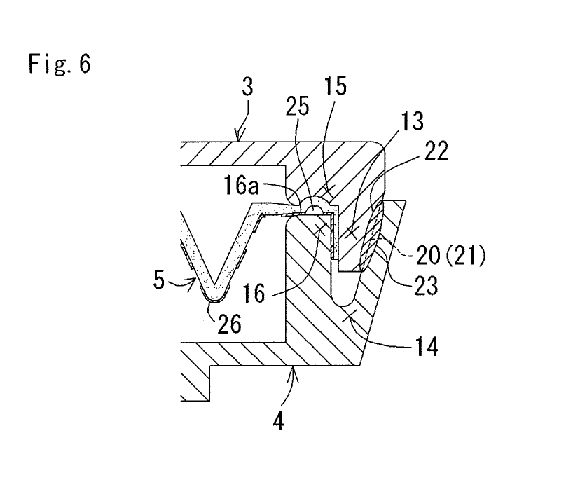

In the filter according to the first embodiment, as shown in FIG. 6, a grid net 26 may be disposed on a surface of the filter medium 5 and protruding portions 25 that penetrate the mesh of the grid net 26 may be formed on the vertical press surfaces 16a. The grid net inhibits deformation of the filter medium when the filter is in use while the penetration of the mesh of the grid net by the protruding portions more reliably suppress dislodgement of the filter medium from the filter casing.

Examples of materials for the grid net include synthetic resin, such as polyethylene, and metallic material, such as stainless steel and iron.

### 2. Manufacturing Method for Filter

In a second embodiment, a manufacturing method for the filter according to the first embodiment includes the steps of holding the end portion of the filter medium between the holding portions in a bent position by mutually joining the first case member and the second case member, and with the end portion held in the bent position, irradiating a laser beam to one of the first and second case members via the other case member so as to form the welded portions, thus connecting the first and second case members.

### EXAMPLES

Hereinafter, an example of the present invention will be described in detail with reference to the attached drawings. Note that an oil filter for an automatic transmission of a vehicle is used as an example of a filter in the example.

### (1) Filter Configurations

As shown in FIG. 1, a filter 1 of this example includes an upper case member 3 (which is an example of a first case member according to the present invention), and a lower case member 4 (which is an example of a second case member according to the present invention), which are joined together to form a filter chamber 2 therebetween. The filter 1 also includes a filter medium 5 with an end portion 12 held between the upper and lower case members 3 and 4.

The lower case member 4 has a fluid inlet 7 formed therein to introduce an unfiltered fluid, whereas the upper case member 3 has a fluid outlet 8 formed therein to discharge the fluid after it is filtered by the filter medium 5. The upper case member 3 is made of a synthetic resin that has laser absorbency. Conversely, the lower case member 4 is made of a synthetic resin that has laser transparency. The filter medium 5 is made of a non-woven fabric with a corrugated portion 11 and the pair of end portions 12 connected to the respective ends of the corrugated portion 11. The filter medium 5 divides the filter chamber 2 into a dusty side 2a and a clean side 2b.

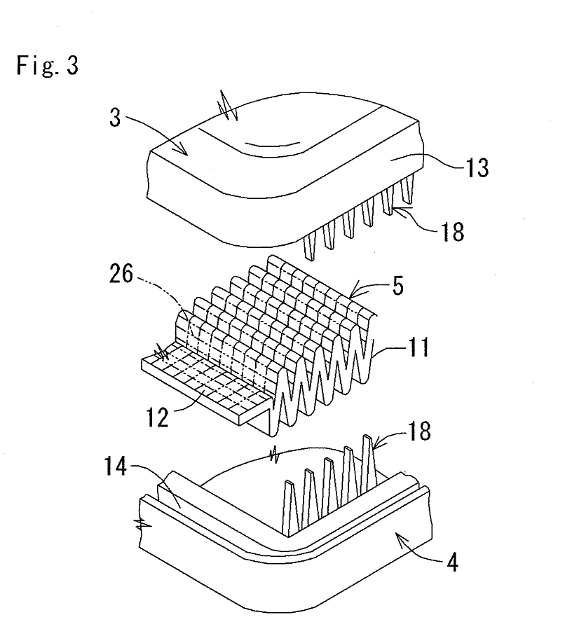

As shown in FIGS. 2 and 3, a frame-like convex portion 13 extending in a joining direction P is provided along a periphery of the upper case member 3. In addition, a frame-like concave portion 14 extending in the joining direction P is provided along a periphery of the lower case member 4 such that the convex portion 13 is engaged with the concave portion 14. Holding portions 15 and 16 are provided on the upper and lower case members 3 and 4, respectively, on the filter chamber side of where the convex portion 13 engages the concave portion 14, such that the end portion 12 of the filter medium 5 is held between the holding portions 15 and 16 in a bent position. The holding portions 15 and 16 include vertical press surfaces 15a and 16a, respectively, that press an inner end portion 12a of the filter medium 5 in the joining direction P, and lateral press surfaces 15b and 16b, respectively, that press an outer end portion 12b of the filter medium 5 in a direction orthogonal to the joining direction P. A bending angle “a” between the inner end portion 12a and the outer end portion 12b of the filter medium 5 is set to 90 degrees (see FIG. 1). Note that a side end portion of the corrugated portion 11 of the filter medium 5 are held by comb-teeth-shaped portions 18 that are provided on the upper and lower case members 3 and 4 (see FIG. 3).

The end portion 12 of the filter medium 5 is adapted to have a thickness t1 (see FIG. 4) of 1 mm before being compressed by the vertical press surfaces 15a and 16a and the lateral press surfaces 15b and 16b. The inner and outer end portions 12a and 12b of the filter medium 5 are adapted to have the same thickness t2 and t3 (see FIG. 2) of 0.35 mm after being compressed by the vertical press surfaces 15a and 16a and the lateral press surfaces 15b and 16b. Accordingly, the compression ratio of the end portion 12 of the filter medium 5 between before and after pressing (t1/t2, t1/t3) is approximately 2.9.

As also shown in FIG. 2, tapered abutment surfaces 20 and 21 are formed on the convex portion 13 and the concave portion 14, respectively, on the side of the engagement between the convex portion 13 and the concave portion 14 that is opposite to the filter chamber 2. The tapered abutment surfaces extend in a direction intersecting the joining direction P. Welded portions 22 and 23 welded together by a laser beam are provided on the abutment surfaces 20 and 21, respectively.

### (2) Manufacturing Method for Filter

Hereinafter, a manufacturing method for the filter 1 will be described with reference to the attached drawings.

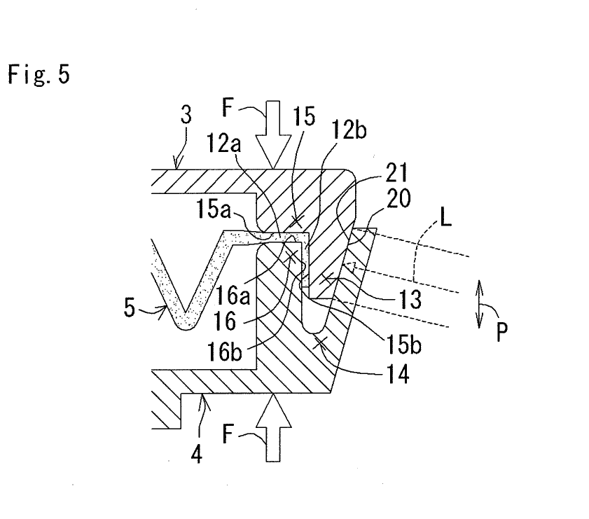

First, as shown in FIG. 4, the upper and lower case members 3 and 4 are mutually joined with the end portion 12 of the filter medium 5 interposed therebetween. As a result, the end portion 12 of the filter medium 5 is held between the holding portions 15 and 16 in a 90-degree bent position, as shown in FIG. 5. Then, the inner end portion 12a of the filter medium 5 is pressed by the vertical press surfaces 15a and 16a in the joining direction P, while the outer end portion 12b of the filter medium 5 is pressed by the lateral press surfaces 15b and 16b in the direction orthogonal to the joining direction P. Subsequently, a laser beam L is irradiated to a predetermined area of the upper case member 3 via the lower case member 4 while force F is applied in the joining direction P to the upper and lower case members 3 and 4 that are joined together. This laser beam irradiation melts a portion to be welded of the upper case member 3, and this melting heat in turn melts a portion to be welded of the lower case member 4, as shown in FIG. 2. As a result, welded portions 22 and 23 are formed in the upper and lower case members 3 and 4, respectively. Thus, the two case members 3 and 4 are connected and the filter 1 is obtained.

Note that, in a filter 1 constructed as described above, the oil flowing into the dusty side 2a of the filter chamber 2 from the fluid inlet 7 reaches the clean side 2b after filtered by the filter medium 5. Subsequently, the filtered oil flows out of the clean side 2b of the filter chamber 2 from the fluid outlet 8 to the exterior of the filter 1.

### (3) Effects of the Example

According to the filer 1 of the present example, the holding portions 15 and 16, which hold the end portion 12 of the filter medium 5, are spaced apart from the welded portions 22 and 23, which are welded together by the laser beam L. This configuration inhibits the conduction of melting heat generated by the laser beam to the filter medium 5, thus preventing undesirable effect on the shape or the material of the filter medium 5. Also, the end portion 12 of the filter medium 5 is held in a bent position between the holding portions 15 and 16, and the inner end portion 12a of the filter medium 5 is pressed by the vertical press surfaces 15a and 16a in the joining direction P, with the outer end portion 12b of the filter medium 5 being pressed by the lateral press surfaces 15b and 16b in the direction orthogonal to the joining direction P. Accordingly, even if the oil flow exerts force on the upper case member 3 in a direction to open the casing when the filter 1 is in use, the filter medium 5 can be firmly supported between the upper and lower case members 3 and 4. Thus, it is possible to prevent the filter medium 5 from being dislodged. Furthermore, since the upper and lower case members 3 and 4 can be connected by a single execution of irradiation of the laser beam L, an inexpensive and simply structured filter 1 can be provided.

According to this example, the convex portion 13 is provided along the periphery of the upper case member 3, the concave portion 14 is provided along the periphery of the lower case member 3, the holding portions 15 and 16 are provided on the first and second case members 3 and 4, respectively, on the filter chamber side of where the convex portion 13 engages the concave portion 14, and the welded portions 22 and 23 are provided on the first and second case members 3 and 4, respectively, on the side of where the convex portion 13 engages the concave portion 14 opposite to the filter chamber 2. This structure allows engagement between the convex portion 13 and the concave portion 14 in a way that augments the mechanical bonding force during the welding by the laser beam L and suppresses the warpage of the upper and lower case members 3 and 4, thus ensuring firm and secure connection of the case members 3 and 4. This structure also permits the holding portions 15 and 16 to be sufficiently spaced apart from the welded portions 22 and 23 and thus effectively inhibits the conduction of melting heat generated by the laser beam to the filter medium 5.

According to the example, the lateral press surfaces 15b and 16b extending in the joining direction P are provided on the holding portions 15 and 16, respectively, on the filter chamber side of where the convex portion 13 engages the concave portion 14, and the tapered abutment surfaces 20 and 21 extending in the direction intersecting the joining direction P are provided on the convex portion 13 and the concave portion 14, respectively, on the side of where the convex portion 13 engages the concave portion 14 opposite to the filter chamber 2. This structure reduces the gap generated at the engagement of the convex portion 13 and the concave portion 14 by the warpage of the welded portions 22 and 23, thereby augmenting the welding strength therebetween.

It should be noted that the present invention is not limited to the example described above, but may be modified, changed, or altered, depending on application and purpose thereof without departing from the scope and spirit of the present invention. More particularly, instead of providing the flat vertical press surfaces 15a and 16a as well as the flat lateral vertical press surfaces 15b and 16b as in the above example, protruding portions 25 may be formed on the vertical press surfaces 15a and 16a and/or the lateral vertical press surfaces 15b and 16b so as to press a part of the end portion 12 of the filter medium 5, as shown in FIG. 6. This can further suppress dislodgement of the filter medium 5 from the filter casing. Additionally, a grid net 26 (indicated in chain double dashed lines in FIG. 3) may be disposed on the surface of the filter medium 5 in order to inhibit deformation of the medium 5 when the filter is in use. In this case, preferably, the protruding portions 25 on the vertical press surfaces 15a and 16a and/or the lateral press surfaces 15b and 16b are adapted to penetrate the mesh of the grid net 26. The grid net 26 inhibits deformation of the filter medium 5 when the filter is in use, while the penetration of the mesh of the grid net 26 by the protruding portions 25 more reliably prevents dislodgement of the filter medium 5 from the filter casing.

According to the example, as described above, the lateral press surfaces 15b and 16b, extending in the joining direction P, are provided on the holding portions 15 and 16, respectively, on the filter chamber side of where the convex portion 13 engages the concave portion 14, and the tapered abutment surfaces 20 and 21, extending in the direction intersecting the joining direction P, are provided on the convex portion 13 and the concave portion 14, respectively, on the side of where the convex portion 13 engages the concave portion 14 opposite to the filter chamber 2. The present invention, however, is not limited to this configuration. For example, as shown FIG. 7, alternate lateral press surfaces 15b and 16b, extending in the direction intersecting the joining direction P, may be provided on the holding portions 15 and 16, respectively, on the filter chamber side of where the convex portion 13 engages the concave portion 14, while the tapered abutment surfaces 20 and 21, extending in the direction intersecting the joining direction P, may be provided on the side of where the convex portion 13 engages the concave portion 14 opposite to the filter chamber 2. Alternatively, as shown in FIG. 8, lateral press surfaces 15b and 16b, extending in the joining direction P, may be provided on the filter chamber side of where the convex portion 13 engages the concave portion 14, while alternate abutment surfaces 20 and 21, extending in the joining direction, may be provided on the convex portion 13 and the concave portion 14, respectively, on the side of where the convex portion 13 engages the concave portion 14 opposite to the filter chamber 2.

Although the filter medium 5 having a corrugated shape is described in the above example, the present invention is not limited to this. For example, a filter medium made of a single flat sheet or two or more flat sheets stacked together may be used instead. In this case, the entire periphery of the filter medium may be held in a bent position.

The filter of the present invention may be used to filter a fluid containing contaminants. In particular, the filter of the present invention may be advantageously used as an oil filter for an automatic transmission of a vehicle.

What is claimed is:

1. A filter comprising:
a first case member and a second case member mutually joined to form a filter chamber; and
a filter medium having an end portion held between said first and second case members, wherein:
each of said first and second case members includes a holding portion for holding said end portion of said filter medium in a bent position and a welded portion spaced apart from said holding portion and welded by a laser beam; and
said holding portion includes:
a vertical press surface for pressing an inner end portion of said filter medium in a joining direction between said first and second case members; and
a lateral press surface for pressing an outer end portion of said filter medium in a direction intersecting said joining direction.

2. The filter according to claim 1, wherein one of said first and second case members includes on a periphery thereof a convex portion extending in said joining direction and the other case member includes on a periphery thereof a concave portion extending in said joining direction and engaged with said convex portion, and further wherein said holding portion is provided on said filter chamber side of where said convex portion engages said concave portion and said welded portion is provided on the side of where said convex portion engages said concave portion opposite to said filter chamber.

3. The filter according to claim 2, wherein said convex portion and said concave portion have respective tapered abutment surfaces that abut each other.

4. The filter according to claim 3, wherein said filter medium includes on a surface thereof a grid net and said vertical press surface has a plurality of protruding portions that penetrates a mesh of said grid net.

5. A manufacturing method for the filter of claim 1, comprising the steps of:
holding said end portion of said filter medium between said holding portions in a bent position by mutually joining said first case member and said second case member; and
irradiating a laser beam to one of said first and second case members via the other case member, with said end portion being held in said bent position, so as to form said welded portion, thus connecting said first and second case members; wherein,
in said holding step, said vertical press surface presses said inner end portion of said filter medium in said joining direction, while said lateral press surface presses said outer end portion of said filter medium in a direction intersecting said joining direction.

6. The manufacturing method according to claim 5, wherein one of said first and second case members includes on a periphery thereof a convex portion extending in said joining direction and the other case member includes on a periphery thereof a concave portion extending in said joining direction and engaged with said convex portion, and further wherein said holding portion is provided on said filter chamber side of where said convex portion engages said concave portion and said welded portion is provided on the side of where said convex portion engages said concave portion opposite to said filter chamber.

7. The manufacturing method according to claim 6, wherein said convex portion and said concave portion have respective tapered abutment surfaces that abut each other.

8. The manufacturing method according to claim 7, wherein said filter medium includes on a surface thereof a grid net and said vertical press surface has a plurality of protruding portions that penetrates a mesh of said grid net.
